(19) United States
(12) Patent Application Publication
(10) Pub. No.: US 2004/0105042 A1
(43) Pub. Date: Jun. 3, 2004

(54) [PIXEL STRUCTURE AND FABRICATING METHOD THEREOF]

(76) Inventors: Shui Huang, Taipei (TW); Chen Shih Yuan, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/605,458

(22) Filed: Sep. 30, 2003

(30) Foreign Application Priority Data
Oct. 1, 2002 (TW) 91122605

(51) Int. Cl. G02F 1/136

(52) U.S. Cl. 349/44

(57) ABSTRACT

A pixel structure and a fabrication method thereof. The pixel structure is formed over a transparent substrate. The pixel structure includes a scan line, a gate insulation layer, a data line, a shelling layer, a thin film transistor, a passivation layer, a contact and a pixel electrode. The shelling layer is formed on each side of the data line above the transparent substrate. The shelling layers on each side of the data line are electrically connected to prevent an unbalance parasitic capacitance between the data line and the neighboring shelling layers that may lead to shot mura.

### CROSS REFERENCE TO RELATED APPLICATIONS

This application claims the priority benefit of Taiwan application serial no. 91122605, filed Oct. 1, 2002.

### BACKGROUND OF INVENTION

1. Field of Invention

The present invention relates to a semiconductor device structure and its method of fabrication. More particularly, the present invention relates to the pixel structure of a thin film transistor liquid crystal display (TFT-LCD) and fabricating method thereof.

2. Description of Related Art

A thin film transistor liquid crystal display (TFT-LCD) is an assembly comprising a thin film transistor array substrate, a color filter array substrate and a liquid crystal layer. The thin film transistor array substrate includes a plurality of thin film transistors organized into an array such that each thin film transistor corresponds to a pixel electrode. Each thin film transistor has a gate, a channel layer, a source terminal and a drain terminal and serves as a switching element for a liquid crystal display unit.

Operation of each thin film transistor unit is similar to a conventional semiconductor MOS device. Each thin film transistor has three terminals (a gate terminal, a source terminal and a drain terminal). In general, a thin film transistor may be classified as an amorphous silicon type or a polysilicon type. The amorphous silicon type of thin film transistor has been developed for some time and hence the fabricating technique is more standardized. The fabrication of an amorphous silicon thin film transistor involves forming a gate electrode, a channel layer, a source/drain terminal, a pixel electrode and a passivation layer over a substrate.

FIG. 1 is a top view of a conventional pixel structure. FIG. 2 is a cross-sectional view along line segments I-I″ of FIG. 1. A pixel structure like the one in FIGS. 1 and 2 is fabricated in several steps. First, a transparent substrate 100 is provided. Thereafter, a gate electrode 102 and a scan line 130 having connection with the gate 102 are formed over the transparent substrate 100. At the same time, shelling metallic layers 132a and 132b are formed over the transparent substrate 100. The shelling metallic layers 132a and 132b are formed on one side of an area destined to form a data line. Next, a gate insulation layer 104 is formed over the transparent substrate 100 covering the gate electrode 102, the scan line 130 and the shelling metallic layers 132a, 132b.

A channel layer 106 is formed over the gate insulation layer 104 above the gate electrode 102. Thereafter, source/drain terminals 108a/108b are formed over the channel layer 106. In the meantime, a data line 140 having connection with the source terminal 108a is formed over the gate insulation layer 104. The data line 140 extends in a direction perpendicular to the direction of extension of the scan line 130. The shelling metallic layers 132a, 132b are located underneath the gate insulation layer 104 on each side of the data line 140. The gate electrode 102, the channel layer 106 and the source/drain terminals 108a/108b together constitute a thin film transistor 120.

A passivation layer 110 is formed over the transparent substrate 100 covering the thin film transistor 120 and the data line 140. An opening that exposes the drain terminal 108b of the thin film transistor 120 is formed in the passivation layer 110. Thereafter, a pixel electrode 114 is formed over the passivation layer 110. The pixel electrode 114 is electrically connected to the drain terminal 108b of the thin film transistor 120 through the opening 112. The patterned pixel electrode 114 may also cover the shelling metallic layer 132a, 132b.

Due to the closeness between the shelling metallic layers 132a, 132b and the data line 140 and the closeness between the shelling metallic layers 132a, 132b and the pixel electrode 114, parasitic capacitance is produced. Since the shelling metallic layers 132a, 132b are both in a floating state, the extent of parasitic capacitance is rather difficult to gauge and control. In some cases, the patterned data line 140 may deviate from the standard position. For example, the distance between the data line 140 and the shelling metallic layer 132a is smaller than the distance between the data line 140 and the shelling metallic layer 132b as shown in FIG. 1. Consequently, parasitic capacitance of the data line 140 with respect to the shelling metallic layers 132a and 132b is different. In other words, charge distribution between the data line 140 relative to the shelling metallic layers 132a, 132b is uneven. The uneven charge distribution has the effect of producing a non-uniform color and gray scale in the two display regions. Such discrepancy in neighboring display regions is frequently referred to as having a shot mura.

### SUMMARY OF INVENTION

Accordingly, one object of the present invention is to provide a pixel structure and a fabricating method thereof capable of minimizing difference in parasitic capacitance between a data line and neighboring shelling metallic layers so that a highly uniform display is produced.

To achieve these and other advantages and in accordance with the purpose of the invention, as embodied and broadly described herein, the invention provides a pixel structure suitable for fabricating over a transparent substrate. The pixel structure includes a scan line, a gate insulation layer, a data line, a shelling layer, a thin film transistor, a passivation layer, a contact and a pixel electrode. The scan line is formed over the transparent substrate. The gate insulation layer is formed over the transparent substrate covering the scan line. The data line is formed over the gate insulation layer. The data line extends in a direction perpendicular to the direction of extension of the scan line. The shelling layer is formed on the transparent substrate on each side of the data line. The shelling layers on each side of the data line are electrically connected. In this invention, each shelling layer comprises a shelling section and a connective section. The shelling section is positioned on each side of the data line. The connective section joins up the shelling sections on each side of the data line. In addition, the shelling layer of this invention can be a block of shelling metallic layer that crosses from one side of the data line to the other. The thin film transistor is also formed over the transparent substrate. The thin film transistor has a gate electrode, a channel layer and a source/drain terminal. The source terminal is electrically connected to the data line, the gate electrode is electrically connected to the scan line and the channel layer is formed over the gate insulation layer above the gate electrode. The passivation layer is formed over the transparent substrate covering the thin film transistor and the data line. The contact is formed inside the passivation layer. The pixel electrode is formed over the passivation layer. The pixel electrode is electrically connected to the drain terminal through the contact.

This invention also provides a pixel structure suitable for fabricating over a transparent substrate. The pixel structure includes a scan line, a gate insulation layer, a data line, a shelling layer, a dielectric layer, a thin film transistor, a passivation layer, a contact and a pixel electrode. The scan line is formed over the transparent substrate. The gate insulation layer is formed over the transparent substrate covering the scan line. The data line is formed over the gate insulation layer. The data line extends in a direction perpendicular to the direction of extension of the scan line. The shelling layer is formed over the transparent substrate on each side of the data line. The dielectric layer is formed between the gate insulation layer and the data line above the shelling layer. In this embodiment, the shelling layers on each side of the data line may or may not be electrically connected together. In other words, the setup of electrical connection between the shelling layers is optional because the shelling layers and the data line are isolated from each other by the gate insulation layer and the dielectric layer. A thin film transistor is also formed over the transparent substrate. The thin film transistor has a gate electrode, a channel layer and a source/drain terminal. The source terminal is electrically connected to the data line, the gate electrode is electrically connected to the scan line and the channel layer is formed over the gate insulation layer above the gate electrode. The passivation layer is formed over the transparent substrate covering the thin film transistor and the data line. The contact is formed inside the passivation layer. The pixel electrode is formed over the passivation layer. The pixel electrode is electrically connected to the drain terminal through the contact.

This invention also provides a method of fabricating a pixel structure on a transparent substrate. First, a gate electrode and a scan line having electrical connection with the gate electrode are formed over the transparent substrate. At the same time, shelling layers are formed over the transparent substrate. The shelling layers are formed on each side of an area destined for forming a data line and are electrically connected together. In this invention, the shelling layer comprises a shelling section and a connective section. The shelling section is formed on the side of a data line while the connective section joins up the shelling sections on each side of the data line. In addition, the shelling layer can be a block of patterned shelling metallic layer that crosses from one side of the data line to the other. Thereafter, a gate insulation layer is formed over the transparent substrate covering the gate electrode, the scan line and the shelling layers. A channel layer is formed over the gate insulation layer above the gate electrode. A source/drain terminal is formed over the channel layer. In the meantime, a data line having connection with the source terminal is formed over the gate insulation layer. The gate electrode, the channel layer and the source/drain terminals together constitute a thin film transistor. A passivation layer is formed over the transparent substrate covering the thin film transistor and the data line. An opening that exposes the drain terminal is formed over the passivation layer. A pixel electrode is formed over the passivation layer such that the pixel electrode is electrically connected to the drain terminal through a contact within the opening.

This invention also provides an alternative method of fabricating a pixel structure over a transparent substrate. First, a gate electrode and a scan line having electrical connection with the gate electrode are formed over the transparent substrate. At the same time, shelling layers are formed over the transparent substrate. The shelling layers are formed on each side of an area destined for forming a data line. The shelling layers on each side of the data line may be electrically connected together by selection. Thereafter, a gate insulation layer is formed over the transparent substrate covering the gate electrode, the scan line and the shelling layers. A channel layer is formed over the gate insulation layer above the gate electrode. A dielectric layer is formed over the gate insulation layer above the shelling layers. A source/drain terminal is formed over the channel layer. In the meantime, a data line having connection with the source terminal is formed over the gate insulation layer. The gate electrode, the channel layer and the source/drain terminals together constitute a thin film transistor. The shelling layers and the data line are isolated from each other by the gate insulation layer and the dielectric layer. A passivation layer is formed over the transparent substrate covering the thin film transistor and the data line. An opening that exposes the drain terminal is formed over the passivation layer. A pixel electrode is formed over the passivation layer such that the pixel electrode is electrically connected to the drain terminal through a contact within the opening.

In this invention, the shelling layers on each side of the data line are electrically connected. Hence, parasitic capacitance of the capacitors resulting from proximity of the data line with neighboring shelling layers on each side of the data line is able to balance out and prevent the occurrence of shot mura in the display device.

Aside from a gate insulation layer, an additional dielectric layer may also be introduced. Since capacitance of a capacitor is inversely proportional to the thickness of the dielectric layer between the metallic electrodes of a capacitor, thickening with a dielectric layer is able to bring down the capacitance of a parasitic capacitor. Ultimately, mura shot in the display due to parasitic capacitance is attenuated.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view of a conventional pixel structure.

FIG. 2 is a cross-sectional view along line segments I-I′ of FIG. 1.

FIG. 3 is a top view of a pixel structure according to a first preferred embodiment of this invention.

FIG. 4 is a cross-sectional view along line segments II-II′ of FIG. 3.

FIG. 5 is a top view of a pixel structure according to a second preferred embodiment of this invention.

FIG. 6 is a cross-sectional view along line segments III-III′ of FIG. 5.

FIG. 7 is a cross-sectional view of a pixel structure fabricated according to another preferred embodiment of this invention.

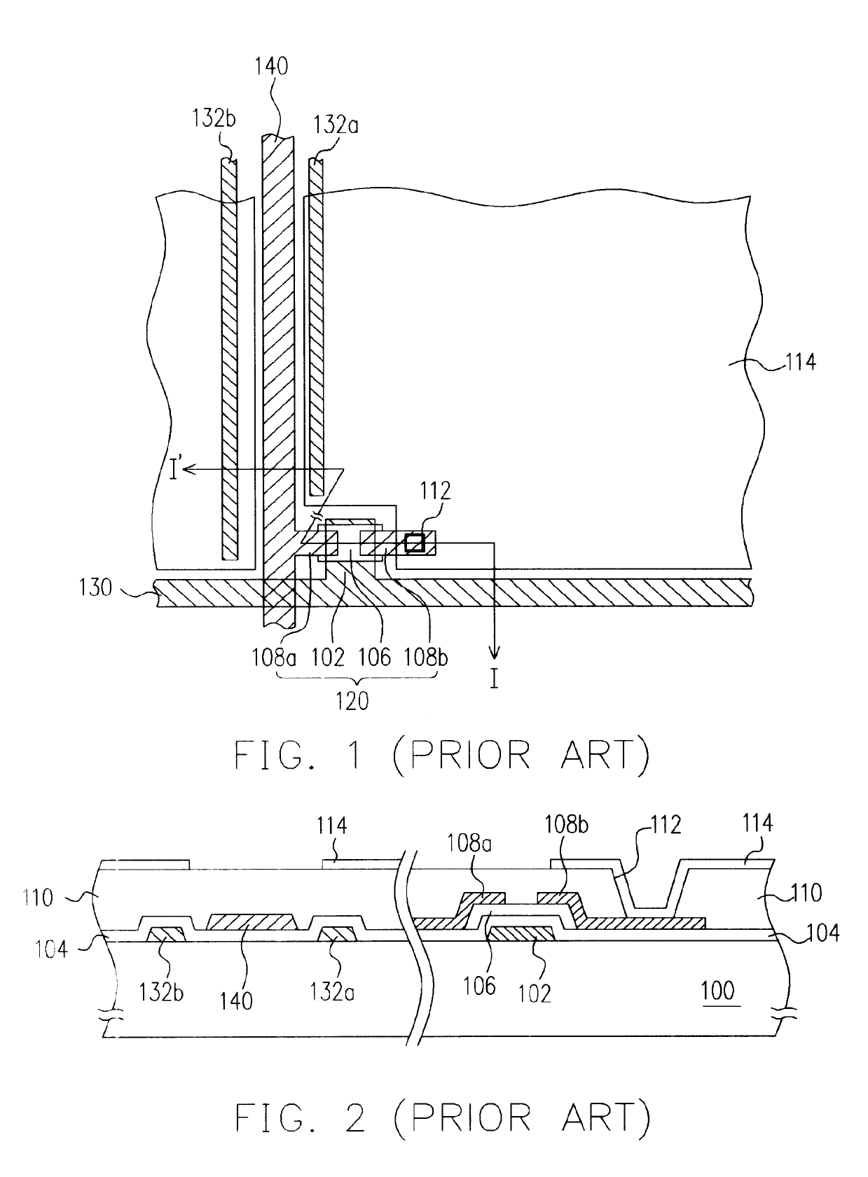

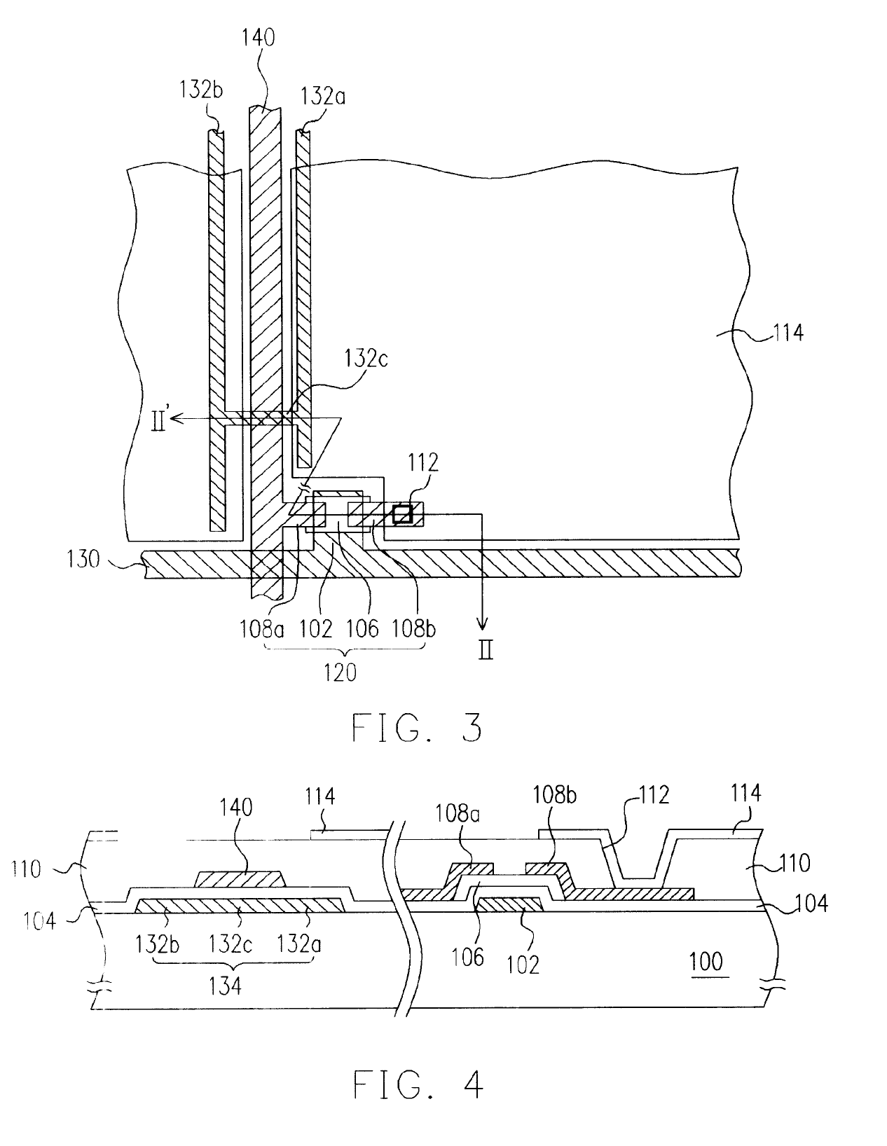

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

FIG. 3 is a top view of a pixel structure according to a first preferred embodiment of this invention. FIG. 4 is a cross-sectional view along line segments II-II″ of FIG. 3. Several steps are required to fabricate the pixel structure shown in FIGS. 3 and 4. First, a transparent substrate 100 such as a glass substrate or a plastic substrate is provided. A gate electrode 102 and a scan line 130 having connection with the gate electrode 102 are formed over the transparent substrate 100. At the same time, a shelling layer 134 is formed over the transparent substrate 100. The shelling layer 134 comprises a pair of shelling sections 132a, 132b and a connective section 132c. The shelling sections 132a, 132b are formed on each side of an area destined to form a data line. The connective section 132c joins up the shelling sections 132a and 132b.

In this embodiment, the gate electrode 102, the scan line 130 and the shelling layer 134 are made from a metallic material such as tantalum, titanium or aluminum. Thereafter, a gate insulation layer 104 is formed over the transparent substrate 100 globally, thereby covering the gate electrode 102, the scan line 130 and the shelling layer 134. The gate insulation layer 104 is a silicon nitride layer or a silicon oxide layer, for example.

A channel layer 106 is formed over the gate insulation layer 104 above the gate electrode 102. An ohmic contact layer (not shown) is subsequently formed on the surface of the gate channel 106. The channel layer 106 is fabricated using a material such as amorphous silicon (a-Si) and the ohmic contact layer is fabricated using a material such as doped amorphous silicon (n+-Si).

A pair of source/drain terminals 108a/108b is formed over the channel layer 106. In the meantime, a data line 140 having connection with the source terminal 108a is formed over the gate insulation layer 104. The data line 140 extends in a direction perpendicular to the direction of extension of the scan line 130. The shelling layer 134 is located on each side of the data line 140 underneath the gate insulation layer 104. The gate electrode 102, the channel layer 106 and the source/drain terminals 108a/108b together constitute a thin film transistor 120.

A passivation layer 110 is formed over the transparent substrate 100 covering the thin film transistor 120 and the data line 140. Thereafter, an opening 112 that exposes the drain terminal 108b of the thin film transistor 120 is formed in the passivation layer 110. A pixel electrode 114 is formed over the passivation layer 110. The pixel electrode 114 and the drain terminal 108 of the thin film transistor 120 are electrically connected through a contact inside the opening 112. In addition, the patterned pixel electrode may also cover a portion of the shelling layer 134.

In this invention, the shelling sections 132a, 132a are electrically connected together through the connective section 132c. Hence, the parasitic capacitors formed between the data line 140 and the shelling section 132a, 132b on each side of the data line 140 may balance each other out and prevent any non-uniformity or shot mura in the pixel display unit.

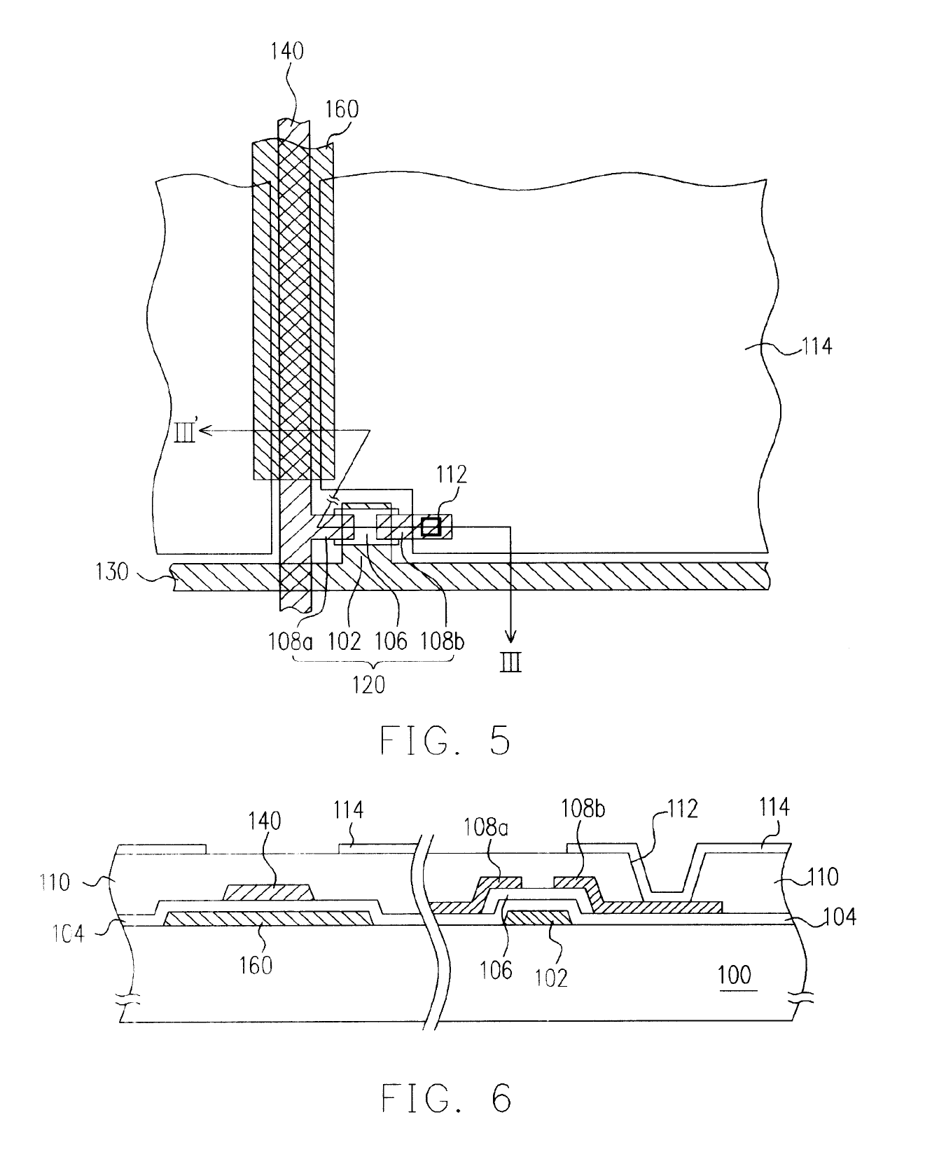

FIG. 5 is a top view of a pixel structure according to a second preferred embodiment of this invention. FIG. 6 is a cross-sectional view along line segments III-III″ of FIG. 5. Similar steps are required to fabricate the pixel structure shown in FIGS. 5 and 6. First, a gate electrode 102 and a scan line 130 are formed over a transparent substrate 100. At the same time, a shelling layer 160 is also formed over the transparent substrate 100. In the second embodiment, however, the shelling layer 160 is a block of shelling metallic layer that crosses over from one side of an area destined to form a data line to the other side. Thereafter, a gate insulation layer 104 is formed over the transparent substrate 100 so that the gate electrode 102, the scan line 130 and the shelling layer 160 are covered.

Just as in the aforementioned embodiment of this invention, a channel layer 106, a pair of source/drain terminals 108a/108b and a data line 140 having connection with the source terminal 108a are sequentially formed over the transparent substrate 100 to produce a thin film transistor 120. Thereafter, a passivation layer 110, a contact 112 and a pixel electrode 114 are formed to build a complete pixel structure.

In the second embodiment, the shelling layer 160 underneath the data line 140 is a block of shelling metallic layer that crosses from one side of the data line 140 to the other. Hence, the potential on each side of the data line 140 is equal and prevents any non-uniformity or shot mura in the pixel display unit.

The pixel structure of this invention is suitable for forming over a transparent substrate 100. The pixel structure includes a scan line 130, a gate insulation layer 104, a data line 140, a shelling layer 134 (or a shelling layer 160), a thin film transistor 120, a passivation layer 110, a contact 112 and a pixel electrode 114.

The scan line 130 is formed over the transparent substrate 100. The gate insulation layer 104 is formed over the transparent substrate 100 covering the scan line 130. The data line 140 is formed over the gate insulation layer 104 and the data line 140 extends in a direction perpendicular to the direction of extension of the scan line 130.

In addition, the shelling layer 134 is formed over the transparent substrate 100 on each side of the data line 140. The shelling layer 134 on each side of the data line 140 is electrically connected. In this embodiment, the shelling layer 134 consists of a pair of shelling sections 132a, 132b and a connective section 132c. The shelling sections 132a and 132b are positioned on each side of the data line while the connective section 132c joins up the respective shelling sections 132a and 132b. The shelling layer 160 may also be a block of shelling metallic layer 160 that crosses over the data line 140.

Furthermore, the thin film transistor 120 is positioned over the transparent substrate 100. The thin film layer 120 includes a gate electrode 102, a channel layer 106 and a pair of source/drain terminals 108a/108b. The source terminal 108a and the data line 140 are electrically connected. The gate electrode 102 and the scan line 130 are electrically connected. The channel layer 106 is formed over the gate insulation layer 104 above the gate electrode 102. The passivation layer 110 is above the transparent substrate 100 covering the thin film transistor 120 and the data line 140. The contact 112 is buried inside the passivation layer 110. The pixel electrode 114 is constructed over the passivation layer 110 such that the pixel electrode 114 and the drain terminal 108b are electrically connected through the contact 112.

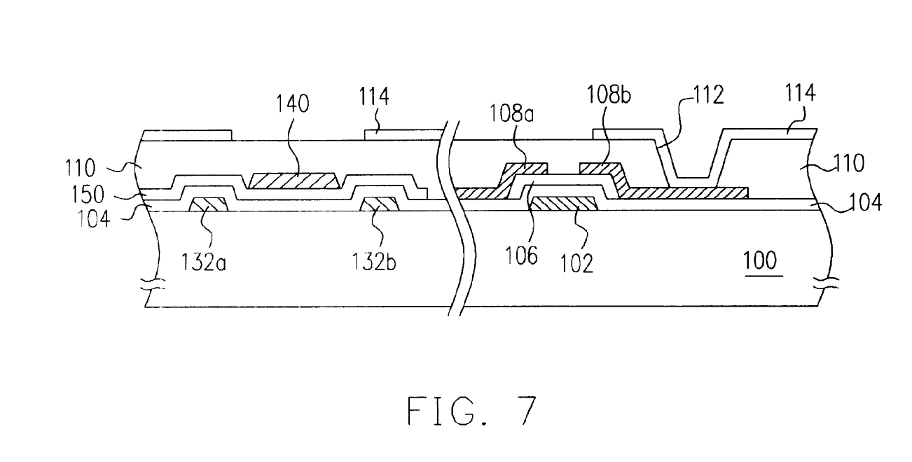

FIG. 7 is a cross-sectional view of a pixel structure fabricated according to another preferred embodiment of this invention. First, a gate electrode 102 and a scan line 130 are formed over a transparent substrate 100. At the same time, shelling layers 132a and 132b are formed over the transparent substrate 100. Thereafter, a gate insulation layer 104 is formed over the transparent substrate 100 to cover the gate electrode 102, the scan line 130 and the shelling layers 132a, 132b. An additional dielectric layer 150 is formed over the gate insulation layer 104 above the shelling layer 132a and 132b. The dielectric layer 150 is fabricated using a material such as silicon nitride.

A channel layer 106, a pair of source/drain terminals 108a/108b and a data line 140 having connection with the source terminal 108a are sequentially formed over the transparent substrate 100 to form a complete thin film transistor 120. Hence, the data line 140 is separated from the shelling layers 132a, 132b by the additional dielectric layer 150 besides the gate insulation layer 104. Finally, a passivation layer 110, a contact 112 and a pixel electrode 114 are formed over the transparent substrate 100 to build a complete pixel structure.

Note that the additional dielectric layer 150 between the data line 140 and the shelling layers 132a, 132b reduces the parasitic capacitance of the capacitors produced between the data line 140 and the respective shelling layers 132a, 132b. In addition, the shelling layers 132a and 132b may be electrically connected by selection. For example, the shelling layers 132a and 132b in FIG. 1 are not electrically connected together. On the other hand, the shelling layers 132a and 132b in FIG. 3 are electrically connected together while the shelling layer 160 in FIG. 5 is a single block that crosses from one side of the data line 140 to the other.

The pixel structure in this embodiment is suitable for constructing over a transparent substrate 100. The pixel structure includes a scan line 130, a gate insulation layer 104, a data line 140, a pair of shelling layers 132a, 132b (or a shelling layer 134, 160), a dielectric layer 150, a thin film transistor 120, a passivation layer 110, a contact 112 and a pixel electrode 114.

The scan line 130 is formed over the transparent substrate 100. The gate insulation layer 104 is formed over the transparent substrate 100 covering the scan line 130. The data line 140 is formed over the gate insulation layer 104 and that the data line 140 extends in a direction perpendicular to the direction of extension of the scan line 130.

In addition, the shelling layers 132a, 132b are formed over the transparent substrate 100 on each side of the data line 140. The dielectric layer 150 is formed in the space between the gate insulation layer 104 above the shelling layers 132a, 132b and the data line 140. The shelling layers 132a, 132b on each side of the data line 140 can be electrically connected by selection. For example, the shelling layers 132a, 132b in FIG. 1 are not electrically connected while the shelling layers 134, 150 in FIGS. 3 and 5 are electrically connected. Anyway, the shelling layers 132a, 132b (or the shelling layers 134, 160) and the data line 140 are separated by the gate insulation layer 104 and the dielectric layer 150.

Furthermore, the thin film transistor 120 is positioned over the transparent substrate 100. The thin film layer 120 includes a gate electrode 102, a channel layer 106 and a pair of source/drain terminals 108a/108b. The source terminal 108a and the data line 140 are electrically connected. The gate electrode 102 and the scan line 130 are electrically connected. The channel layer 106 is formed over the gate insulation layer 104 above the gate electrode 102. The passivation layer 110 is above the transparent substrate 100 covering the thin film transistor 120 and the data line 140. The contact 112 is buried inside the passivation layer 110. The pixel electrode 114 is constructed over the passivation layer 110 such that the pixel electrode 114 and the drain terminal 108b are electrically connected through the contact 112.

In this embodiment, the data line 140 and the shelling layers 132a, 132b (or the shelling layers 134, 160) are separated from each other by the dielectric layer 150 in addition to the gate insulation layer 104. Since the capacitance of a capacitor is inversely proportional to the thickness of its dielectric layer, the additional thickness provided by the dielectric layer 150 reduces the parasitic capacitance between the data line 140 and the shelling layers 132a, 132b (or the shelling layers 134, 160). Ultimately, non-uniformity of pixel display units due to unequal capacitance is greatly minimized.

In this invention, the shelling layers on each side of the data line are electrically connected. Hence, parasitic capacitance of the capacitors resulting from proximity of the data line with neighboring shelling layers on each side of the data line is able to balance out and prevent the occurrence of shot mura in the display device.

Furthermore, a dielectric layer in addition to the original gate insulation layer may also be introduced. Since capacitance of a capacitor is inversely proportional to the thickness of the dielectric layer between the metallic electrodes of a capacitor, thickening with a dielectric layer is able to bring down the capacitance of a parasitic capacitor and attenuate any mura shot in the display.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A pixel structure on a transparent substrate, the pixel structure comprising:
a scan line over the transparent substrate;
a gate insulation layer over the transparent substrate covering the scan line;
a data line over the gate insulation layer, wherein the data line extends in a direction perpendicular to the direction of extension of the scan line;
a shelling layer over the transparent substrate positioned on each side of the data line, wherein the shelling layers on each side of the data line are electrically connected;
a thin film transistor over the transparent substrate, wherein the thin film transistor has a gate electrode, a channel layer and a pair of source/drain terminals, the source terminal is electrically connected to the data line, the gate electrode is electrically connected to the scan line and the channel layer is formed over the gate insulation layer above the gate electrode;
a passivation layer over the transparent substrate covering the thin film transistor and the data line;
a contact within the passivation layer; and
a pixel electrode over the passivation layer, wherein the pixel electrode is electrically connected to the drain terminal through the contact.

2. The pixel structure of claim 1, wherein the shelling layer further includes:
a shelling section over the transparent substrate on each side of the data line; and
a connective section over the transparent substrate, wherein the connective section joins up the shelling section on each side of the data line electrically.

3. The pixel structure of claim 1, wherein the shelling layer includes a block of shelling metallic layer that crosses from one side of the data line to the other.

4. The pixel structure of claim 1, wherein the shelling layer, the gate electrode and the scan line are all fabricated using an identical material.

5. A pixel structure on a transparent substrate, the pixel structure comprising:
a scan line over the transparent substrate;
a gate insulation layer over the transparent substrate covering the scan line;
a data line over the gate insulation layer, wherein the data line extends in a direction perpendicular to the direction of extension of the scan line;
a shelling layer over the transparent substrate on each side of the data line;
a dielectric layer between the data line and the gate insulation layer above the shelling layer;
a thin film transistor over the transparent substrate, wherein the thin film transistor has a gate electrode, a channel layer and a pair of source/drain terminals, wherein the source terminal is electrically connected to the data line, the gate electrode is electrically connected to the scan line and the channel layer is formed over the gate insulation layer above the gate electrode;
a passivation layer over the transparent substrate covering the thin film transistor and the data line;
a contact within the passivation layer; and
a pixel electrode over the transparent substrate, wherein the pixel electrode and the drain terminal are electrically connected through the contact.

6. The pixel structure of claim 5, wherein the dielectric layer includes a silicon nitride layer.

7. The pixel structure of claim 5, wherein the shelling layers on each side of the data line are electrically connected.

8. The pixel structure of claim 7, wherein the shelling layer further includes:
a shelling section over the transparent substrate on each side of the data line; and
a connective section over the transparent substrate, wherein the connective section joins up the shelling section on each side of the data line electrically.

9. The pixel structure of claim 8, wherein the shelling layer includes a block of shelling metallic layer that crosses from one side of the data line to the other.

10. The pixel structure of claim 5, wherein the shelling layer, the gate electrode and the scan line are all fabricated using an identical material.

11. A method of forming a pixel structure, comprising the steps of:
forming a gate electrode and a scan line having connection with the gate electrode over a transparent substrate and forming a shelling layer over the transparent substrate at the same time, wherein the shelling layer is formed on each side of an area destined to form a data line and the shelling layers on each side are electrically connected together;
forming a gate insulation layer over the transparent substrate covering the gate electrode, the scan line an the shelling layer;
forming a channel layer over the gate insulation layer above the gate electrode;
forming a pair of source/drain terminals over the channel layer and forming a data line having connection with the source terminal over the gate insulation layer at the same time, wherein the gate electrode, the channel layer and the source/drain terminals together constitute a thin film transistor;
forming a passivation layer over the transparent substrate covering the thin film transistor and the data line;
forming an opening that exposes the drain terminal in the passivation layer; and
forming a pixel electrode over the passivation layer, wherein the pixel electrode and the drain terminal are electrically connected through a contact in the opening.

12. The method of claim 11, wherein the shelling layer includes a shelling section on each side of the data line and a connective section joining the shelling sections electrically.

13. The method of claim 11, wherein the shelling layer is a block of shelling metallic layer that crosses from one side of the data line to the other side.

14. The method of claim 11, wherein the shelling layer, the gate electrode and the scan line are all fabricated using an identical material.

15. A method of forming a pixel structure, comprising the steps of:
forming a gate electrode and a scan line having connection with the gate electrode over a transparent substrate and forming a shelling layer over the transparent substrate at the same time, wherein the shelling layer is formed on each side of an area destined to form a data line and the shelling layers on each side are electrically connected together;
forming a gate insulation layer over the transparent substrate covering the gate electrode, the scan line and the shelling layer;
forming a channel layer over the gate insulation layer above the gate electrode;
forming a dielectric layer over the gate insulation layer above the shelling layer;
forming a pair of source/drain terminals over the channel layer and forming a data line having connection with the source terminal over the gate insulation layer at the same time, wherein the gate electrode, the channel layer and the source/drain terminals together constitute a thin film transistor;
forming a passivation layer over the transparent substrate covering the thin film transistor and the data line;
forming an opening that exposes the drain terminal in the passivation layer; and
forming a pixel electrode over the passivation layer, wherein the pixel electrode and the drain terminal are electrically connected through a contact in the opening.

16. The method of claim 15, wherein the dielectric layer is a silicon nitride layer.

17. The method of claim 15, wherein the shelling layers on each side of the data line are electrically connected together.

18. The method of claim 17, wherein the shelling layer includes a shelling sections on each side of the data line and a connective section joining the shelling sections electrically.

19. The method of claim 17, wherein the shelling layer is a block of shelling metallic layer that crosses from one side of the data line to the other side.

20. The method of claim 15, wherein the shelling layer, the gate electrode and the scan line are all fabricated using an identical material.
